(19) United States
(12) Patent Application Publication
(10) Pub. No.: US 2013/0035225 A1
(43) Pub. Date: Feb. 7, 2013

(54) ORGANIC/INORGANIC HYBRID CATALYTIC MATERIALS, THEIR PREPARATION, USE IN SELECTIVE PROCESSES AND REACTORS CONTAINING THEM

(71) Applicants: Pierluigi Barbaro, Sesto Fiorentino (IT); Claudio Bianchini, Sesto Fiorentino (IT); Francesca Liguori, Sesto Fiorentino (IT); Haruo Sawa, Kochi (JP); Francesco Vizza, Sesto Fiorentino (IT)

(72) Inventors: Pierluigi Barbaro, Sesto Fiorentino (IT); Claudio Bianchini, Sesto Fiorentino (IT); Francesca Liguori, Sesto Fiorentino (IT); Haruo Sawa, Kochi (JP); Francesco Vizza, Sesto Fiorentino (IT)

(73) Assignee: NIPPON KODOSHI CORPORATION, Kochi (JP)

(21) Appl. No.: 13/120,470

(22) PCT Filed: Mar. 31, 2010
(86) PCT No.: PCT/JP10/56288

§ 371 Date: Oct. 23, 2012

(51) Int. Cl. B01J 31/06; B01J 31/22; B01J 31/24; B01J 31/16

(52) U.S. Cl. 502/4; 502/159; 502/152; 502/155; 502/156

(57) ABSTRACT

A low cost, viable and modular method to prepare new, highly selective catalytic materials, especially “catalytic membranes”, is described. A method for the engineering and use of various types of reactors based on these catalytic membranes, even in a one-pot procedure, is also disclosed. The catalytic membranes are versatile, in terms of variety of chemical reactions promoted, and can be easily reused with negligible catalysts leaching. They are particularly useful, but not limited to, the asymmetric hydrogenation of substituted α,β unsaturated acids or esters.

### CROSS REFERENCE TO RELATED APPLICATIONS

This is a U.S. national stage of international application No. PCT/JP2010/056288, filed on Mar. 31, 2010.

### FIELD OF THE INVENTION

The present invention relates to new catalytic hybrid inorganic/polymeric materials, particularly catalytic hybrid inorganic/polymeric membranes, exhibiting high selectivity, activity, stability, reusability and low metal leaching in a variety of catalytic chemical reactions. More specifically, the present invention relates to the manufacture of polyvinyl alcohol-based, low cost hybrid materials, especially membranes, and to the immobilization of selective catalysts onto them, to produce catalytic materials showing the above-specified performance, their assembly in reactors and their use in chemical processes. The applications of such materials are particularly useful, but not limited to, the asymmetric hydrogenations of prochiral, unsaturated organic substrates.

### BACKGROUND

The development of sustainable, i.e. cost-effective and environmentally friendly, highly-selective processes for the production of fine chemicals (pharmaceuticals, agrochemicals, fragrances, etc.) is a current major concern at the industrial level.

At present, most industrial processes showing high activity and selectivity, particularly stereo- or enantio-selectivity, are based on the use of homogeneous-phase, molecular catalysts. These compounds commonly consist of heavy (noble) metal complexes containing highly elaborated (chiral) ligands. Besides being complicated to be prepared and expensive, these catalysts suffer from the difficulty of their recovery from the reaction mixture and their reuse. Also, separation of the products from the catalyst and the solution (usually an organic solvent) invariably leads to the emission of volatile pollutants.

On the other hand, compared to homogeneous-phase catalysts, heterogeneous catalysts are easier processed, separated, reused and integrated in reactor equipments and, thus, chemical industry has a strong preference for them. However, heterogeneous catalysts usually do not provide comparable selectivities.

There is therefore a clear need to develop new concepts bridging heterogeneous and homogeneous catalysis, and to apply these to the engineering of catalytic devices for the industrial production of fine chemicals, in order to meet both environmental and economical targets. This issue is of maximum importance in asymmetric catalysis were the cost of chiral ligands often exceed that of the noble metal used.

Amongst the methods developed over the last decades, the immobilization of chemical catalysts onto solid, insoluble support materials has provided significant benefits in terms of clean separation of the expensive catalysts from the reaction products and their reuse. Chem. Rev., 102, 3215-3216 (2002); Science, 299, 1702-1706 (2003); Adv. Synth. Catal., 348, 1337-1340 (2006) and Chem. Eur. J., 12, 5972-5990 (2006) are recent, extensive reviews concerned with immobilization materials, techniques and the corresponding catalysts.

Preformed, molecular catalysts can be conveniently immobilized by non-covalent binding. This methodology is usually referred to as “heterogenization of homogeneous catalysts”. The topic was reviewed recently, for example, in Top. Catal., 25, 71-79 (2003); Top. Catal., 40, 3-17 (2006); Chem. Eur. J., 12, 5666-5675 (2006); Ind. Eng. Chem. Res., 44, 8468-8498 (2005); J. Mol. Cat. AChemical, 177, 105-112 (2001), Chem. Rev., 109,515-529 (2009) and Chem. Rev., 109, 360-417 (2009). Advantages of this approach are multiplea) the preparation of heterogeneous catalysts with predictable selectivity is potentially enabled, b) there is no need for chemical modification, neither of the support nor of the catalyst, c) the problems arising from metal loading are minimized, d) the catalyst active sites can be easily characterized. Usual drawbacks are a lower activity, compared to the corresponding homogeneous-phase catalyst, and the occurrence of metal leaching.

A variety of solids, often highly sophisticated, have been exploited for the purpose of immobilize molecular catalysts, including inorganic (reviewed e.g. in Chem. Rev., 102, 3495-3524 (2002), Chem. Rev., 102, 3615-3640 (2002) and J. Catal., 239, 212-219 (2006)), organic (reviewed e.g. in Chem. Rev., 109, 815-838 (2009), Chem. Rev., 102, 3717-3756 (2002) and Chem. Rev., 102, 3275-3300 (2002)) and hybrid materials (reviewed e.g. in Chem. Rev., 102, 3589-3614 (2002) and Catal. Rev., 44, 321-374 (2002)). Apart from the influence of the support on the catalyst efficiency (both activity and selectivity) the chemical, mechanical and thermal stability of the material is of outmost importance as far as the practical use of the catalyst is concerned.

The physical form of the solid is also of significance. When monoliths or beads (from 30 μm diameter on) are used, the shape and the size of the material allow for easily and quantitative recovery of the catalyst by simple filtration or decantation. By contrast, when powdered materials are used with a size of about 1 μm or less, they might not settle in the solution within a short time, a nd it is very difficult to collect them for recycling. The separation of the catalyst thus requires centrifugation or ultrafiltration. Very fine powders may also clog or poison the reactors or the autoclaves employed in the catalytic experiments.

Besides being commonly used as separation medium, polymeric fibers and membranes are among the most useful solids usable as support for the engineering of catalytic materials. When showing catalytic activity, membranes are usually referred to as “catalytic membranes”. Their classification, preparation, properties and applications are reviewed in a number of recent papers, for example in Catal. Today, 56, 147-157 (2000); Chem. Rev., 102, 3779-3810 (2002); Adv. Synth. Catal., 348, 1413-1444 (2006); Top. Catal., 29, 59-65 (2004); Top. Cat., 29, 3-27 (2004); App. Cat. AGeneral, 307, 167-183 (2006); Top. Cat., 29, 67-77 (2004). Compared to other support materials membranes provide additional opportunities(i) polymeric membranes can drive the catalytic reactions due to the different absorption and diffusion of reagents and products within the membrane; (ii) polymeric membranes can be prepared by controlling their mechanical, chemical and thermal stability to yield the desired permeability and affinity for reagents and products; (iii) shape and size of polymeric membranes allow for the easy engineering of diverse reactor types, (iv) the use of catalytic membranes allows the reactions to be performed in a membrane reactor (CMR) in which the reaction and separation processes can be combined in a single stage.

At present, however, rare examples are known related to the preparation and use of polymeric, catalytic membranes for highly (enantio)selective processes. In these cases, the membrane usually consists of chemical catalyst (a transition metal catalyst) embedded into a polymer.

Chem. Comm., 388-389 (2002); Angew. Chem., Int. Ed. Engl., 35, 1346-1347 (1996); Chem. Commun., 2407-2408 (1999), TetrahedronAsymmetry, 8, 3481-3487 (1997) and Chem. Commun., 2323-2324 (1997) describe the occlusion of [((R,R)-MeDuPHOS)Rh(COD)]CF₃SO₃, ((S)-BINAP)Ru(p-cymene)Cl and ((S,S)-SALEN)MnCl complexes [DuPHOS=1,2-bis-(2R,5R)-dimethyl(phosphacyclopentyl)-benzene, COD=cyclooctadiene, BINAP=2,2′-bis(diphenylphospino)-1,1′-binapthyle, SALEN=N,N′-bis(3,5-di-tert-butylsalicylidene)-1,2-cyclohexanediamine] in polydimethylsiloxane (PDMS) films and their use in the asymmetric hydrogenation of methyl 2-acetamidoacrylate (MAA), methyl acetoacetate and in the epoxidation reaction of olefins, respectively. The efficiency of the immobilized catalyst was comparable to that of the corresponding homogeneous catalysts in the case of the epoxidation, both in terms of activity and selectivity (in water/heptane), whereas significantly lower activities were observed (typically from one to two order of magnitude) in the case of the hydrogenation catalysts (in water, methanol or glycols). In the latter case, the conversions were increased (up to four-fold) by the incorporation of silica or toluene p-sulfonic acid into the membrane, likely due to the decreased hydrophobicity of the membrane. However, the stability of these systems was insufficient in terms of leaching, due to the complexity of the interactions of the catalysts with the polymer, the solvent, the substrate and the products. A careful selection of the solvents can effectively decrease the metal leaching of the epoxidation catalyst (as low as 1%), which was never completely avoided. Acceptable metal leaching was observed for the ruthenium-based hydrogenation catalysts (Ca. 0.2%), whereas low to massive leaching (from 0.9 to 31%) was observed for the rhodium complex, which was strongly dependent on the solvent (the best being water and the worse being methanol). Catalyst regeneration and reuse was possible by washing the membrane with the reaction solvent before addition of a new reaction mixture.

TetrahedronAsymmetry, 13, 465-468 (2002) describes the immobilization of [((R,R)MeDuPHOS)Rh(COD)]CF₃SO₃ into polyvinyl alcohol (PVA) films and its use for the enantioselective hydrogenation of MAA. The metal catalyst was entrapped into the polymer during the membrane synthesis. Slightly cross-linked (3%) PVA was used to this purpose. Compared to the corresponding homogeneous catalyst, much lower conversions were obtained with the membrane-assisted catalyst. Rhodium leaching into solution was directly correlated to both the swellability of the membrane and the solubility of the metal complex in the solvent used in the hydrogenation reaction, being higher for methanol (47%) and lower for xylene (0.7%). The choice of water as the reaction solvent (leaching 4.2%) was motivated by the need to minimize leaching while maintaining the catalysts activity, but this choice actually limits the applicability of the method due to the poor solubility of organic substrates. Catalyst reuse was possible as above.

A limited number of other applications using polymer-based membranes embedding a molecular chemical catalyst were described which, however, are restricted to unselective chemical reactions, For example, J. Mol. Cat. AChemical, 282, 85-91(2008) and Appl. Catal. AGeneral, 335, 37-47 (2008) describe the use of perfluorinated polymeric membranes containing ruthenium porphyrin complexes in the catalytic aziridination of styrenes. J. Membrane Sci., 114, 1-11 (1996) and React. Polym., 14, 205-11 (1991) report the catalytic hydrogenation of cinnamaldehyde, 1,3-and 1,5-cyclooctadiene by Pd, Rh, Ru and Ni nanoparticles embedded in PVA membranes.

In 1998 (WO 9828074; U.S. Pat. No. 6,005,148) Augustine et al. disclosed a method to anchor preformed homogeneous catalysts onto various solid supports based on the use of heteropoly acids (HPA) as anchoring agents. Complexes of ruthenium and rhodium were used as homogeneous catalysts, while materials such as alumina, carbon, silica, and clay were used as supports. The HPA phosphotungstic acid, silicotungstic acid, phosphomolybdic acid and silicomolybdic acid were used as anchoring agents. The immobilized catalysts were typically prepared by the consecutive treatment of the support with an HPA solution, followed by treatment of the material obtained with a solution of the metal complex. The immobilization is accomplished through the interaction of the metal atom of the catalyst with the support mediated by the HPA. This technique was successfully applied to the asymmetric, catalytic hydrogenation of prochiral olefins using anchored rhodium chiral-diphosphine catalysts using ethanol as solvent, as described in App. Cat. AGeneral, 256, 69-76 (2003); Chem. Commun., 1257- 1258 (1999); J. Mol. Cat. A Chemical, 216, 189-197 (2004). These catalysts were as active and selective as the homogeneous analogs and could be reused several times with almost constant efficiency. Catalysts leaching was typically at ppm level.

The same method was successively adopted to produce a few selective, heterogenized catalysts. J. Catal., 227, 428-435 (2004) describes the use of ruthenium-phosphine complexes immobilized onto NaY zeolite through phosphotungstic acid (PTA) in the selective hydrogenation of trans-cinnamaldehyde and crotonaldehyde. Appl. Catal.AGeneral, 303, 29-34 (2006) describes the enantioselective hydrogenation of (Z)-α-acetamidocinnamic acid derivatives by Al₂O₃-PTA immobilized rhodium chiral complexes.

PVA membranes entrapping HPAs, but without any molecular catalyst anchored, show catalytic activities in limited unselective chemical processes. Polymer 16, 209-215 (1992) describes PVA-PTA membranes catalyzing the ethanol dehydration reaction. J. Membrane Sci., 159, 233-241 (1999) describes the catalytic esterification of acetic acid with n-butanol by PTA-PVA membranes. J. Membrane Sci., 202, 89-95 (2002) reports on the dehydration of butanedil to tetrahydrofuran catalyzed by PTA-PVA membranes. Catal. Today, 82, 187-193 (2003) and Catal. Today, 104, 296-304 (2005) describe the hydration reaction of α-pinene catalyzed by phosphomolybdic acid-PVA membranes.

The current state of the art clearly indicates that polymer-based catalytic membranes for highly (stereo)selective chemical reactions have never been successfully developed, likewise neither reactors nor processes based on these polymer-based catalytic membranes have been manufactured. Hybrid inorganic I polymeric membranes embedding preformed chemical catalysts are a promising strategy either in terms of mechanical, thermal, chemical stability and reusability of the catalysts as well as low-metal leaching into solution.

One of the inventors of the present application had suggested new hybrid inorganic/polymeric membranes in Electrochemistry, 72, 111-116 (2004), JP 3889605, U.S. Pat. No. 7,101,638, JP 3856699. These membranes consist of a hybrid chemical compound of inorganic oxides and polyvinyl alcohol (PVA), in which the inorganic oxides are chemically combined with PVA through its hydroxyl groups. These materials are produced by simple processes in aqueous solution, in which salts of inorganic oxides are neutralized by acid with PVA co-existing. By this method, the nascent and active inorganic oxides generated by neutralization combine and hybridize with PVA to form the hybrid compound. The hybridized chemical compounds are distinguished from mixtures of inorganic oxides and PVA, that is, their chemical properties are remarkably changed from their raw materials. For example, once hybridized materials are insoluble in any solvents including hot water.

However, these membranes have been designed and developed for application as solid electrolytes, especially in fuel cells originally. Accordingly, their use as support to immobilize molecular catalysts requires their modification as well as the development of an appropriate technique for the heterogenization process.

### SUMMARY

At least an embodiment of the present invention relates to the preparation and use of catalytic materials, especially catalytic membranes, for selective chemical reactions. The term “catalytic material (membrane)” is used hereinafter to denote a hybrid inorganic/PVA material (membrane) onto which a preformed metal catalyst is immobilized. The “preformed metal catalyst” is any catalytically active material, typically a metal complex, comprising at least one transition metal atom or ion from group IB, IIB, IIIB, IVB, VB, VIB, VIIB, VIII of the Periodic Table of Elements to which one or more ligands are attached. The ligands, both chiral and achiral, can be species able to coordinate transition metal atom or ions, and include phosphines, amines, imines, ethers, carbonyl, alkenes, halides and their mixture thereof. When a chiral catalyst comprising a chiral ligand is used, the catalytic material or the catalytic membrane so far obtained is denoted as “chiral catalytic material” or “chiral catalytic membrane”, respectively.

At least an embodiment of the present invention relates to the preparation of catalytic materials by contacting a preformed hybrid inorganic/PVA material with an appropriate solution of a preformed metal catalyst.

At least another embodiment of the present invention relates to the assembly of the aforementioned catalytic materials, particularly membranes, into chemical reactors and their use in chemical processes, for example hydrogenations, dehydrogenations, hydrogenolysis, hydroformylations, carbonylations, oxidations, dihydroxylations, epoxidations, aminations, phosphinations, carboxylations, silylations, isomerizations, allylic alkylations, cyclopropanations, alkylations, allylations, arylations, methatesis and other C-C bond forming reactions. The applications of such catalytic materials is particularly useful, but not limited to, the asymmetric hydrogenations of prochiral, unsaturated organic substrates, such as substituted α,β unsaturated acids or esters.

In at least another embodiment of the present invention, the preparation and the use of the said catalytic materials in chemical processes are carried out by a one-pot procedure. These processes can be carried out either in solution or in a liquid-gas two phase system; in a batch reactor using either a fixed-bed catalytic assembly or a rotating catalytic membrane assembly, or a continuous flow reactor.

### DETAILED DESCRIPTION OF PREFERRED EMBODIMENTS

At least an embodiment of the present invention allows for the easy preparation and use of new catalytic materials, especially membranes, for highly selective organic reactions, either in two consecutive, separated steps or by a one-pot procedure. The catalytic materials (membranes) of at least an embodiment of the invention include two componentsa “preformed hybrid inorganic/polymeric material (membrane)” and a preformed, homogeneous chemical catalyst. The homogeneous catalyst is typically a molecular “metal complex” comprising a metal atom and an organic ligand, whose activity and selectivity in the homogeneous phase is known.

The “preformed hybrid inorganic/polymeric material” is preferably the hybrid of inorganic oxides and the polymer having hydroxyl groups. Furthermore, the inorganic oxide is preferably silicic acid compounds, tungstic acid compounds, molybdic acid compounds and stannic acid compounds. Silicic acid means the compound contains SiO₂ as its basic compositional unit as well as containing water molecules, and can be denoted by SiO₂.xH₂O. In at least an embodiment of the present invention, silicic acid compound means silicic acid and its derivatives, or any compounds containing silicic scid as a main component. Tungstic acid means the compound containing WO₃ as its basic compositional unit as well as containing water molecules, and can be denoted by WO₃.xH₂O. In at least an embodiment of the present invention, tungstic acid compound means tungstic acid and its derivatives, or any compounds containing tungstic acid as a main component. Molybdic acid means the compound containing MoO₃ as its basic compositional unit as well as containing water molecules, and can be denoted by MoO₃.xH₂O. In at least an embodiment of the present invention, molybdic acid compound means molybdic acid and its derivatives, or any compounds containing molybdic acid as a main component. Stannic acid means the compound containing SnO₂ as its basic compositional unit as well as containing water, and can be denoted by SnO₂.xH₂O. In at least an embodiment of the present invention, stannic acid compound means stannic acid and its derivatives, or any compounds containing stannic acid as a main component. Silicic acid compounds and tungstic acid compounds are employed more preferably to manufacture the present materials.

Silicic acid compounds, tungstic acid compounds, molybdic acid compounds and stannic acid compounds are allowed to contain other elements as substituents, to have non-stoichiometric composition and/or to have some additives, as far as the original properties of silicic acid, tungstic acid, molybdic acid and stannic acid can be maintained. Some additives, such as phosphoric acid, sulfonic acid, boric acid, titanic acid, zirconic acid, alumina and their derivatives are also allowed.

For the inorganic/polymeric hybrid material, the polymer having hydroxyl groups is suitable for the polymeric component, because hydroxyl groups are useful for combining to the inorganic oxide. Moreover, the water-soluble polymer is more preferable, because, in most cases, hybridization processes are made in aqueous environment. From these points of view, PVA is considered to be the most suitable. However, perfect PVA is not necessarily required, and some modifications, such as partial substitution of some other groups for hydroxyl groups or partial block copolymerization are allowed.

Furthermore, the other polymers, for example, polyolefin polymers such as polyethylene and polypropylene, polyacrylic polymers, polyether polymers such as polyethylene oxide, and polypropylene oxide, polyester polymers such as polyethylene terephthalate and polybutylene terephthalate, fluorine polymers such as polytetrafluoroethylene and polyvinylidene fluoride, glycopolymers such as methyl cellulose, polyvinyl acetate polymers, polystyrene polymers, polycarbonate polymers, epoxy resin polymers or other organic and inorganic additives are allowed to be mixed into the hybrid material.

The inorganic/polymeric hybrid materials are made by a simple aqueous process, in which the salts of inorganic oxides, such as silicate, tungstate, molybdate and stannate are neutralized by acid in the aqueous solution containing the polymer having hydroxyl groups, such as PVA. In this process, silicate, tungstate, molybdate and stannate change to the silicic acid compounds, the tungstic acid compounds, the molybdic acid compounds and the stannic acid compounds, respectively, by neutralization. These newborn and nascent compounds are so active that they have a tendency to combine each other. However, in this method, the polymer co-exists close to the inorganic compounds, so the newborn and nascent compounds combine to the hydroxyl groups of the polymer by dehydration combination. The membranes can be made by the common casting method using the above-mentioned precursor solution after the co-existent neutralization process. The fibers of this hybrid compound can be made, for example by the spunbond method, the melt-blow method or the electro-spinning method.

The inorganic/polymeric hybrid materials show high affinity to water or the other solvents having high polarity, and swell by absorbing these solvents. The swelling degree of the membrane can be adjusted by the aldehyde treatment (Electrochemistry, 72, 111-116 (2004), JP 4041422, U.S. 7,396,616). The aldehyde treatment means that the free hydroxyl groups of the polymer remaining in the inorganic/polymeric hybrid are combined with aldehydes, such as glutaraldehyde, phthalaldehyde, glyoxal and butyraldehyde by contacting the membrane with a solution or a gas reactant including the aldehyde. By the aldehyde treatment, the polymer component is cross-linked or becoming nonpolar (hydrophobic) to adjust the swelling degree.

Some porous matrix sheets, such as cloth, non-woven cloth or paper can be used in order to reinforce the inorganic/polymeric hybrid membranes. Any materials, such as polyester, polypropylene, polyethylene, polystyrene and nylon can be employed for the matrix for reinforcement as far as showing enough endurance.

According to at least an embodiment of the present invention, by molecular “metal complex” is meant any catalytically active material which contains at least one transition metal atom or ion from group IB, IIB, IIIB, IVB, VB, VIB, VIIB, VIII of the Periodic Table of Elements to which one or more ligands are attached. Suitable transition metal atoms or ions include Sc, Ti, V, Cr, Mn, Co, Ni, Cu, Zn, Zr, Mo, Ru, Rh, Pd, Ag, W, Re, Os, Ir, Pt, Au. Ligands can be any organic or metal-organic specie containing one or more donor atoms having a free electronic pair, for instance among phosphorus, nitrogen, oxygen, sulfur, halogen atoms, or mixed-donor atoms set, as well as carbonyls, carboxyls, alkyls, alkenes, dienes, alkynes or any other moieties which are able to coordinate the metal atoms or ions. Mixture of the above mentioned ligands are also contemplated herein. Suitable achiral ligands include, but are not limited tophosphines, amines, imines, ethers, cyclopentadiene (Cp), cyclooctadiene (COD), norbornadiene (NBD), methanol, acetonitrile, dimethylsulfoxide. Suitable chiral ligands include, but are not limited to(R,R) or (S,S)-BINAP [2,2′-bis(diphenylphosphino)-1,1′.binaphtalene], (R,R) or (S,S)-DIOP [2,3-O-isopropylidene-2,3- dihydroxy-1,4-bis(diphenylphosphino)butane], (R) or (S)-Monophos [(3,5-dioxa-4-phosphacyclohepta[2,1-a;3,4-a]dinaphtalen-4-yl)dimethylamine], (R,R) or (S,S)-TMBTP [4,4′-bis(diphenylphosphino)-2,2′,5,5′-tetramethyl-3,3′-bithiophene]. Examples of metal complexes contemplated by the present invention include, but are not limited to[(-)-(TMBTP)Rh(NBD)]PF₆, [(-)-BINAP)Rh(NBD)]PF₆, [(-)-DIOP)Rh(NBD)]PF₆, [(-)-Monophos)₂Rh(NBD)]PF₆.

The catalytic material (membrane) is obtained by the immobilization of the homogeneous catalyst onto the preformed support material (membrane) by a straightforward procedure which avoids any chemical manipulation neither of the ligand nor of the complex or the support material, as well as the addition of any anchoring agent or chemical modifier. The catalytic material thus obtained performs as a heterogeneous catalyst which shows selectivities comparable to those observed in the homogeneous phase, but with the great advantage of being insoluble in the reaction solvent and, hence, easily removed from the reaction mixture by simple decantation and reused. Metal leaching in solution is extremely low in each catalyst reuse. For the abovementioned reasons, the catalytic materials (membranes) of at least an embodiment of the present invention are particularly useful in a wide variety of organic transformations and, particularly, in highly (enantio) selective reactions for which applications in the pharmaceutical, agrochemical or fragrance industry are envisaged.

The interactions responsible for the immobilization of the preformed homogeneous catalyst onto the hybrid material may be based on a combination of non-covalent electrostatic bonds, van der Waals forces, donor-acceptor interactions or other adsorption phenomena which, irrespective of their exact nature, are strong enough to result in an effective anchoring of the metal complex onto the support material and in the possible use of the catalytic material thus obtained in several organic chemical reactions with a minimal loss of metal complex in solution, even when a solvent in which the homogeneous catalyst is soluble is used. On the other hand, the interactions are such not to interfere with the stereo- or enantio-selection ability of the molecular complex once immobilized on the support material, so that the selectivity provided by the catalyst is usually retained on passing from the homogeneous to the heterogeneous phase. This makes the present invention particularly suited for the design and production of catalytic materials featuring predictable selectivities.

The immobilization procedure, which essentially consists in stirring a solution of the desired metal complex in the presence of a preformed hybrid material (membrane), followed by washing, is extremely simple, low-cost, modular (in terms of immobilized catalysts and preformed membranes used) and versatile (in terms of variety of catalytic reaction accessible). The catalytic membranes obtained perform differently depending on the molecular catalyst immobilized and on the support useda selection of the catalytic material for selected applications and with desired performance is thus possible, based on a proper combination of the support and the metal complex.

The catalytic membranes of at least an embodiment of the present invention can be manufactured and used either in two-step procedure or in a single-pot sequence. The former involves a first step in which the catalytic membrane is obtained and stored under an inert atmosphere, followed by a second step in which it is used in an autoclave or in a chemical reactor for a selected chemical reactions. The second involves the direct preparation of the catalytic membrane in the same autoclave in which the following catalyzed reaction is performed, without the need to remove the catalytic membrane or open the reactor prior of its use. This latter procedure is particularly useful, but not limited to, in the case that the catalytic membranes have to be used in liquid-gas phase reactions carried out under a high-pressure of a gas reactant.

The catalytic membranes can be adapted for use either in a fixed-bed (with stirred reaction solution) or in a rotating membrane assembly reactor. In both cases, the catalytic membranes can be easily and straightforwardly reused by removing the reaction solution of the previous reaction cycle, for example by simple decantation, and adding a new batch of solution containing the substrate, under the proper gas atmosphere. The heterogeneous nature of the catalytic membranes (materials), ensured by the absence of any catalytic activity of the reaction solution and by the negligible metal loss, allows for minimization of any impurity leached in the reaction solvent containing the desired product and, hence, in its recover without the need of any further purification step.

According to at least an embodiment of the present invention, the catalytic materials (membranes) are prepared by stirring a solution of a metal complex in an appropriate solvent and in the presence of a preformed hybrid inorganic/polymeric material (membrane) at a temperature from −40° C. to 150° C. and for a period from 0.5 to 48 hours. Stirring is accomplished either with a fixed membrane and a stirred solution or with a rotating membrane dipped in the above mentioned metal complex solution. Suitable solvents include, but are not limited toalcohols (preferably methanol), glycols, water, ethers, ketones, esters, aliphatic and aromatic hydrocarbons, alkyl halides. Concentration of the metal complex solution ranges from 1·10⁻⁴ M to 1·10₂ M, while typical amount of inorganic/polymeric material ranges from 20 g to 200 g per 1 g metal in the metal complex, typical areas of inorganic/polymeric membrane ranges from 0.5 to 20 cm². The catalytic material is washed repeatedly with the solvent used for the immobilization, before being dried under a stream of nitrogen. All the above manipulations required for the preparation of the catalytic materials (membranes) must be carried out under an inert atmosphere depending whether the metal complex is air-sensitive or not. The catalytic materials (membranes) thus obtained can be stored under nitrogen and is ready-to-use for the subsequent reactions. For the purpose of evaluate the metal loading in the catalytic materials (membranes), the materials (membranes) are dried under high vacuum overnight and analyzed to give a typical metal content of ca. 0.1 % to 20% by weight.

According to at least an embodiment of the present invention, the catalytic materials prepared as above can be used to catalyze a variety of chemical reactions which include, but are not limited tohydrogenations, dehydrogenations, hydrogenolysis, hydroformylations, carbonylations, oxidations, dihydroxylations, epoxidations, aminations, phosphinations, carboxylations, silylations, isomerizations, allylic alkylations, cyclopropanations, alkylations, allylations, arylations, methatesis and other C-C bond forming reactions. These reactions can be carried out either in solution or in a liquid-gas two phase system. Further, the catalytic membranes can be adapted to the engineering of batch reactors, working either in a fixed-bed or in a rotating membrane mode, or continuous flow reactors for those skilled in the art. When used in a batch mode, the catalytic materials are typically introduced in the reactor in the presence of a solution containing the substrate and the reactants. When a gas reactant is to be used, it will be introduced in the reactor at the desired pressure in the range from 0.01 MPa to 8 MPa. Suitable solvents include, but are not limited toalcohols (preferably methanol), glycols, water, ethers, ketones, esters, aliphatic and aromatic hydrocarbons, alkyl halogenides. Typical substrate concentration are in the range 1·10⁻² M to 10 M. Substrate:catalyst ratio, based on the measured metal content in the catalytic membrane, can vary from 10:1 to 100.000:1. Reactions can be performed with stirring in the temperature range from −40° C. to 150° C. Due to the fact that the catalytic materials are insoluble solids and that the catalysts immobilized on to them are heterogeneous, the reaction solution can be easily recovered at any time by simple decantation and the catalytic material recycled by simple addition of a fresh solution containing the substrate and the reactants. Viability of the use of water as solvent is also worthy to be underlined because of its environmental compatibility.

According to at least an embodiment of of the present invention, the catalytic membranes can be prepared and used by a one-pot technique as follows. The hybrid inorganic/polymeric membrane is introduced in the reactor and a solution of a metal complex in an appropriate solvent is then added. Concentration of the metal complex solution ranges from 1·10⁻⁴ M to 1·10⁻² M, while typical areas of inorganic/polymeric membrane ranges from 0.5 to 20 cm². The mixture is stirred at a temperature from −40° C. to 150° C. and for a period from 0.5 to 48 hours. After that time, the catalytic membrane prepared in-situ is washed repeatedly with the solvent used for the immobilization. All the above manipulations must be carried out under an inert atmosphere depending whether the metal complex used is air-sensitive or not. A solution containing the substrate and the reactants is introduced in the reactor. When a gas reactant is to be used, it will be introduced in the reactor at the desired pressure. Suitable solvents include, but are not limited toalcohols (preferably methanol), glycols, water, ethers, ketones, esters, aliphatic and aromatic hydrocarbons, alkyl halogenides. Typical substrate concentration are in the range 1·10² M to 10 M. Substrate:catalyst ratio, based on the metal content in the catalytic membrane, can vary from 10:1 to 100.000:1. Reactions can be performed in the temperature range from −40° C. to 150° C. with stirring. The reaction solution can be easily recovered at any time by decantation and the catalytic membrane recycled by simple addition of a fresh solution containing the substrate and the reactants.

In at least an embodiment of of the present invention, the catalytic membranes are used in the enantioselective hydrogenation of prochiral substrates including, but not limited toolefins, imines, enamines, ketones, α, β-unsaturated alcohols, ketones, esters or acids. Preferential metal complexes immobilized, but not limited to, are those of Ir, Rh, Ru, Pd with chiral phosphino, amino or amino-phosphino ligands or their mixture thereof. According to this aspect, a prochiral olefin having the formula

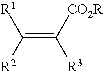

where R is hydrogen, alkyl containing from 1 to about 30 carbon atoms, aryl containing about from 6 to 18 carbon atoms, R¹, R² and R³ are the same or different and containing hydrogen, alkyl containing from 1 to about 30 carbon atoms, alkenyl containing from 1 to about 30 carbon atoms, alkynyl containing from 1 to about 30 carbon atoms, aryl containing about from 6 to 18 carbon atoms, amide, amine, alkoxide containing from 1 to about 30 carbon atoms, ester containing from 1 to about 30 carbon atoms, ketone containing from 1 to about 30 carbon atoms, is hydrogenated by the catalytic membranes to give preferentially one enantiomer of the product. The aryl substituents may also be bicyclic, fused species or containing heteroatoms such as sulfur, oxygen, nitrogen, phosphorus. The prochiral olefin is introduced in the reactor containing the catalytic membrane as solution in a suitable solvent, preferentially, but not limited to, methanol. The hydrogenation reaction is carried out in the temperature range from −40° C. to 150° C., for a period from 0.5 to 48 hours and under a hydrogen pressure ranging from 0.01 MPa to 5 MPa. Preferred prochiral olefins, but not limited to, aremethyl 2-acetamidoacrylate, 2-acetamidoacrylic acid, dimethylitaconate, itaconic acid, methyl 2-acetamidocinnamate, 2-acetamidocinnamic acid.

In conclusion, at least an embodiment of the present invention describes the preparation and use, even by a one-pot procedure, of catalytic materials (membranes) based on hybrid inorganic/polymeric polymers which catalyze a variety of chemical reaction, and particularly highly selective reaction, in mild reaction conditions and with low metal leaching. The catalytic materials (membranes) are adaptable to the engineering of reactors and can be easily and efficiently reused.

The following examples are given to illustrate the scope of the present invention. Incidentally, the invention embodiment is not limited to the examples given here in after.

### EXAMPLE I

This example illustrates the general procedure for the preparation of the hybrid inorganic/polymeric materials, especially membranes, for the immobilization of the preformed molecular catalysts. A raw aqueous solution was obtained by mixing a predetermined amount of sodium silicate, and/or sodium tungstate dihydrate (Na₂WO₆.2H₂O) into a 100 ml of 10 weight % polyvinylalcohol solution. The PVA has average polymerization degree of 3100-3900 and saponification degree of 86-90%. A hydrochloric acid solution of the concentration of 2.4 M was dropped into the raw aqueous solution with stirring for the co-existent neutralization, which induces the hybridization reaction.

This precursor solution was cast on the polyester film of the coating equipment in condition of heating the plate to a temperature of 60-80° C. The coating equipment is R K Print Coat Instruments Ltd. K control coater having a doctor blade for adjusting a gap with a micrometer and a polyester film set on a coating plate. Just after the precursor solution was cast on the plate, the precursor solution was swept by the doctor blade whose gap was adjusted to 0.5 mm at a constant speed in order to smooth the precursor solution in a predetermined thickness. In this condition, water was vaporized from the precursor solution. After fluidity of the precursor solution almost disappeared, another precursor solution was cast on it again, swept by the doctor blade, and then the plate was heated at 110-125° C., for 1-2 hour. After that, the hybrid inorganic/polymeric membrane thus formed was stripped off from the plate to be washed by hot water and dried. Although this is example process for making the membranes, the hybrid inorganic/polymeric material can be formed into any shape and size from the precursor solution.

The aldehyde treatment was made by immersing the inorganic/polymeric hybrid membrane into the hydrochloric acid solution of 1.2 M concentration containing terephthalaldehyde for an hour at a room temperature. Some additives such as polystyrenesulfonic acid or polyethylene glycol can be added as a component of the hybrid inorganic/polymeric materials by mixing them into the precursor solution. In the case of the reinforcement by the matrix sheet, polyester non-woven cloth is sandwiched between the first cast and the second cast of the precursor solution.

Table 1 reports the compositions of the hybrid inorganic/polymeric support membranes.

### EXAMPLE II

This example illustrates a general procedure for the preparation of catalytic membranes by the immobilization of preformed metal catalysts onto of hybrid inorganic/polymeric membranes, prepared as described in the example I, in accordance with at least an embodiment of the method of the present invention described above.

1 cm₂ of hybrid inorganic/PVA membrane support sample, clamped between two Teflon® windows, was introduced in a round-bottomed glass flask equipped with a lateral stopcock. Methanol (10 mL) was introduced into the flask, which was deaereated with three cycles of vacuum/nitrogen. A nitrogen-degassed solution of preformed metal complex catalyst (3·10⁻³mmol) in methanol (5 mL) was then transferred via a Teflon® capillary into the flask under a stream of nitrogen. The flask was stirred at room temperature for 24 h with the aid of an orbital shaker. After that time, the methanol solution was removed by decantation from the flask under a stream of nitrogen, the membrane was carefully washed with consecutive addition/removal of degassed MeOH portions (3×15 mL) and dried under a stream of nitrogen for 4 h. The catalytic membrane assembly thus obtained can be stored under nitrogen and it is ready-to-use in an autoclave for subsequent hydrogenation reactions. For the purpose of evaluate the metal loading in the catalytic membrane, the membrane was removed form the Teflon holder, dried under high vacuum overnight and analyzed by ICP-AES (Inductively Coupled Plasma Atomic Emission Spectroscopy) and EDS (Energy Dispersive X-ray Spectrometry) spectrometry.

Table 2 reports the loading of the anchored metal onto diverse, representative catalytic membrane samples prepared as described in example II.

### EXAMPLE III

This example illustrates the procedure for the preparation of a catalytic membrane based on the immobilization of the preformed rhodium catalyst [((-)-BINAP)Rh(NBD)]PF₆ on the hybrid inorganic/polymeric membrane NK-1 type, in accordance with at least an embodiment of the present invention described in the previous example.

1 cm² (6.76 mg) of the hybrid inorganic/PVA membrane support NK-1 type, clamped between two Teflon® windows, was introduced in a round-bottomed glass flask equipped with a lateral stopcock. Methanol (10 mL) was introduced into the flask, which was deaereated with three cycles of vacuum/nitrogen. A nitrogen-degassed solution of the preformed rhodium catalyst [((-)-BINAP)Rh(NBD)]PF₆ (3.00 mg, 3.1·10⁻³ mmol) in methanol (5 mL) was then transferred via a Teflon® capillary into the flask under a stream of nitrogen. The flask was stirred at room temperature for 24 h with the aid of an orbital shaker. After that time, the methanol solution was removed by decantation from the flask under a stream of nitrogen, the membrane was carefully washed with consecutive addition/removal of degassed MeOH portions (3×15 mL) and dried under a stream of nitrogen for 4 h. The catalytic membrane assembly thus obtained can be stored under nitrogen and it is ready-to-use in an autoclave for subsequent hydrogenation reactions. For the purpose of evaluate the metal loading in the catalytic membrane, the membrane was removed form the Teflon holder, dried under high vacuum overnight and analyzed by ICP-AES to give a rhodium content of 2.91 (w/w %).

### EXAMPLE IV

This example illustrates the general procedure used for the hydrogenation reaction of the various substrates using the catalytic membranes prepared as described in the example II.

The catalytic membrane assembly consisting of a catalytic membrane and a Teflon® holder, and prepared as described in example II, was introduced into a 100 mL stainless steel autoclave equipped with magnetic stirrer and a manometer and whose inner walls were cover with Teflon. The autoclave was degassed with 3 cycles vacuum/nitrogen. A hydrogen-degassed 1.7·10⁻² M methanol solution of the substrate (substrate:anchored metal molar ratio=164:1, based on the data reported in Table 2) was transferred via a Teflon® capillary, under a stream of hydrogen, into the autoclave. The autoclave was flushed with hydrogen for 10 minutes and then charged with the desired hydrogen pressure. The solution in the autoclave was stirred (140 RPM) at room temperature for the desired time. After that time, the autoclave was depressurized and the reaction solution was removed from the bottom drain valve under a stream of nitrogen. A sample of this solution (0.5 μL) was analyzed by gas chromatography to determine both the conversion and the enantiomeric excess (ee) using the appropriate column and conditions. The remaining solution aliquot was used for the determination of the amount of metal leached into solution via ICP-AES analysis.

### EXAMPLE V

This example illustrates the procedure used for the hydrogenation reaction of methyl 2-acetamidoacrylate (MAA) using the catalytic membrane prepared by the immobilization of the preformed rhodium catalyst [((-)-BINAP)Rh(NBD)]PF₆ on the hybrid inorganic/polymeric membrane NK-1 type, in accordance with at least an embodiment of the present invention described in the example III, and performed along the procedure described in the example IV.

The catalytic membrane assembly consisting of a catalytic membrane (NK-1 type with [((-)-BINAP)Rh(NBD)]PF₆ immobilized catalyst, Rh content 2.91 w/w %) and a Teflon® holder, and prepared as described in example II, was introduced into a 100 mL stainless steel autoclave equipped with magnetic stirrer and a manometer and whose inner walls were cover with Teflon. The autoclave was degassed with 3 cycles vacuum/nitrogen. A hydrogen-degassed 1.7·10⁻² M methanol solution (19 mL) of MAA (46.6 mg, 0.32 mmol, MAA:rhodium molar ratio=164:1) was transferred via a Teflon® capillary into the autoclave, under a stream of hydrogen. The autoclave was flushed with hydrogen for 10 minutes and then charged with 5 bar hydrogen pressure. The solution in the autoclave was stirred (140 RPM) at room temperature for 2 hours. After that time, the autoclave was depressurized and the reaction solution was removed from the bottom drain valve under a stream of nitrogen. A sample of this solution (0.5 μL) was analyzed by gas chromatography to determine both the conversion (35.0 %) and the enantiomeric excess (10.4 %) using a 50 m×0.25 mm ID Lipodex-E (Macherey-Nagel) capillary column (helium carrier 24 cm/sec, isotherm 140°C.). The remaining solution aliquot was used for the determination of the amount of metal leached into solution (0.350 ppm) via ICP-AES analysis.

### EXAMPLE VI

This example illustrates a general, one-pot procedure for the preparation of catalytic membranes by the immobilization of preformed metal catalysts onto of hybrid inorganic/polymeric membranes and their use for the hydrogenation reaction of various substrates, in accordance with at least an embodiment of the present invention described above.

2 cm² of hybrid inorganic/PVA membrane support sample clamped between two Teflon® windows were plugged at the bottom-end of a all-Teflon® mechanical stirrer. This assembly was introduced into a 100 mL stainless steel autoclave equipped with a bottom drain valve and a manometer and whose inner walls were covered with Teflon®. The autoclave was charged with methanol (20 mL) and degassed with 3 cycles vacuum/nitrogen. A nitrogen-degassed solution of preformed, metal complex catalyst (6·10⁻³ mmol) in methanol (10 mL) was then transferred via a Teflon® capillary into the autoclave under a stream of nitrogen. The solution in the autoclave was stirred mechanically via the Teflon®—membrane assembly (140 RPM) at room temperature under nitrogen atmosphere for 24 h. After that time, the solution was removed form the autoclave under a stream of nitrogen, and the membrane assembly was carefully washed with consecutive addition/removal of degassed MeOH portions (3×30 mL) into the autoclave via a Teflon® capillary. The catalytic membrane thus obtained is ready-to-use for subsequent hydrogenation reactions and was immediately used as such without remove it from the autoclave, in that case.

For the purpose of evaluate the metal loading in the catalytic membrane, the autoclave can be flushed with a stream of nitrogen for 2 hours; the membrane can be removed form the Teflon holder and the autoclave and dried under high vacuum overnight. The dry catalytic can be analyzed by ICP-AES.

When the one-pot hydrogenation procedure was continued, a hydrogen-degassed 1.7·10⁻² M methanol solution of the substrate (substrate:anchored metal molar ratio=164:1, based on the data reported in Table 2) was transferred via a Teflon® capillary under a stream of hydrogen into the autoclave containing the catalytic membrane. The autoclave was flushed with hydrogen for 10 minutes and then charged with the desired hydrogen pressure. The solution in the autoclave was stirred mechanically via the Teflon® catalytic membrane assembly (140 RPM) at room temperature for the desired time. After that time, the autoclave was depressurized and the reaction solution was removed from the bottom drain valve under a stream of hydrogen. A sample of this solution (0.5 μL) was analyzed by gas chromatography to determine both the conversion and the enantiomeric excess (ee) using the appropriate column and conditions. The remaining solution aliquot was used for the determination of the amount of metal leached into solution via ICP-AES analysis. Recycling experiments were performed as followsa hydrogen-degassed 1.7·10⁻² M methanol solution of the substrate (substrate:anchored metal molar ratio=164:1, based on the data reported in Table 2) was transferred via a Teflon® capillary, under a stream of hydrogen, into the autoclave containing the catalytic membrane after its use in the previous hydrogenation reaction. The autoclave was charged with the desired hydrogen pressure and the solution was stirred mechanically (140 RPM) at room temperature for the desired time. After that time, the autoclave was depressurized and the reaction solution was removed from the bottom drain valve under a stream of hydrogen. A sample of this solution (0.5 μL) was analyzed by gas chromatography to determine both the conversion and the enantiomeric excess (ee). The remaining solution aliquot was used for the determination of the amount of metal leached into solution via ICP-AES analysis.

The results of some of hydrogenation reactions of MAA using the catalytic membranes prepared and used as described in example V are reported in Table 3. Representative data for 5 recycling experiments are also reported.

### EXAMPLE VII

This example illustrates the one-pot procedure for the preparation of a catalytic membrane by the immobilization of the preformed rhodium catalyst [((-)-BINAP)Rh(NBD)]PF₆ onto the hybrid inorganic/polymeric membrane NK-1 type, and its use in the hydrogenation reaction of MAA, in accordance with at least an embodiment of the present invention described in example VI.

2 cm² of the hybrid inorganic/PVA membrane NK-1 type clamped between two Teflon® windows were plugged at the bottom-end of a all-Teflon® mechanical stirrer. This assembly was introduced into a 100 mL stainless steel autoclave equipped with a bottom drain valve and a manometer and whose inner walls were covered with Teflon®. The autoclave was charged with methanol (20 mL) and degassed with 3 cycles vacuum/nitrogen. A nitrogen-degassed solution of the preformed, rhodium complex [((-)-BINAP)Rh(NBD)]PF₆ (6.00 mg, 6.2·10⁻³ mmol) in methanol (10 mL) was then transferred via a Teflon® capillary into the autoclave under a stream of nitrogen. The solution in the autoclave was stirred via the Teflon®—membrane assembly (140 RPM) at room temperature under nitrogen atmosphere for 24 h. After that time, the solution was removed from the autoclave under a stream of nitrogen, and the membrane assembly was carefully washed with consecutive addition/removal of degassed MeOH portions (3×30 mL) into the autoclave via a Teflon® capillary. The catalytic membrane thus obtained is ready-to-use for subsequent hydrogenation reactions and was immediately used as such without open the autoclave nor remove it from the same.

A hydrogen-degassed 1.7·10⁻² M methanol (38 mL) solution of MAA (93.2 mg, 0.65 mmol, MAA:rhodium molar ratio=164:1, based on the data reported in Table 2) was transferred via a Teflon® capillary under a stream of hydrogen into the autoclave containing the catalytic membrane. The autoclave was flushed with hydrogen for 10 minutes and then charged with 5 bar hydrogen pressure. The solution in the autoclave was stirred mechanically via the Teflon® catalytic membrane assembly (140 RPM) at room temperature for the desired time. After that time, the autoclave was depressurized and the reaction solution was removed from the bottom drain valve under a stream of hydrogen. A sample of this solution (0.5 μL) was analyzed by gas chromatography to determine both the conversion (22.33%) and the ee (15.0%) using a 50 m×0.25 mm ID Lipodex-E (Macherey-Nagel) capillary column (helium carrier 24 cm/sec, isotherm 140° C.). The remaining solution aliquot was analyzed by ICP-AES to give 0.324 ppm rhodium leaching into solution. Recycling experiments were performed as followsa hydrogen-degassed 1.7·10⁻² M methanol (38 mL) solution of MAA (93.2 mg, 0.65 mmol, MAA:rhodium molar ratio=164:1, based on the data reported in Table 1) was transferred via a Teflon® capillary, under a stream of hydrogen, into the autoclave containing the catalytic membrane after its use in the previous hydrogenation reaction. The autoclave was charged with 5 bar hydrogen pressure and the solution was stirred mechanically (140 RPM) at room temperature for the desired time. After that time, the autoclave was depressurized and the reaction solution was removed from the bottom drain valve under a stream of hydrogen. A sample of this solution (0.5 μL) was analyzed by gas chromatography to determine both the conversion and the enantiomeric excess (ee). The remaining solution aliquot was used for the determination of the amount of metal leached into solution via ICP-AES analysis. The results for five hydrogenation cycles are reported in Table 3.

TABLE 1
Compositions of hybrid inorganic/polymeric
membranes for catalyst support

| No. | PVA | WO₃^{a} | SiO₂^{b} | PSS^{c} | PEG^{d} | PET^{e} | sd^{f} | ALD^{g} |
|---|---|---|---|---|---|---|---|---|
| NK-1 | 1 | 0.30 | 0.029 | 0.34 | 0 | P | 90% | H |
| CSNKW-1 | 1 | 0.37 | 0.040 | 0.017 | 0 | A | 90% | L |
| CSNKW-3 | 1 | 0.44 | 0.046 | 0.017 | 0.093 | A | 80% | L |
| NKW-6 | 1 | 0.36 | 0.040 | 0 | 0 | A | 90% | L |
| NKS-1 | 1 | 0 | 0.040 | 0.034 | 0 | A | 90% | L |

^{a}Weight ratio of WO₃ to PVA in membranes.
^{b}Weight ratio of SiO₂ to PVA in membranes.
^{c}Weight ratio of Polystyrenesulfonic acid to PVA in membranes.
^{d}Weight ratio of Polyethylene glycol to PVA in membranes.
^{e}Polyestel paper matrix for reinforcement, P: Present, A: Absent.
^{f}Saponification degree.
^{g}Aldehyde treatment, H: Heavy treatment, L: Light treatment.

TABLE 2^{a}
Immobilisation of metal complexes onto catalytic membranes

| Membrane | | |
|---|---|---|
| support type | Rhodium catalyst complex | Rh loading (w/w) (%) |
| NK-1 | [((−)-BINAP)Rh(NBD)]PF₆ | 2.91 |
| NK-1 | [((−)-DIOP)Rh(NBD)]PF₆ | 2.28 |
| NK-1 | [((−)-TMBTP)Rh(NBD)]PF₆ | 2.50 |
| NK-1 | [((−)-Monophos)₂Rh(NBD)]PF₆ | 2.76 |
| CSNKW-1 | [((−)-BINAP)Rh(NBD)]PF₆ | 1.64 |
| CSNKW-1 | [((−)-DIOP)Rh(NBD)]PF₆ | 1.84 |
| CSNKW-1 | [((−)-TMBTP)Rh(NBD)]PF₆ | 2.16 |
| CSNKW-1 | [((−)-Monophos)₂Rh(NBD)]PF₆ | 2.57 |
| CSNKW-3 | [((−)-Monophos)₂Rh(NBD)]PF₆ | 2.27 |
| NKW-6 | [((−)-Monophos)₂Rh(NBD)]PF₆ | 2.81 |
| NKS-1 | [((−)-Monophos)₂Rh(NBD)]PF₆ | 2.13 |

^{a}Examples of data obtained on catalytic membranes prepared using the procedure described in example II. ICP-AES, average value over three samples.

TABLE 3^{a}
Hydrogenation reaction runs of MAA using catalytic membranes

| Membrane | | Cycle | React. | Yield | TOF | ee | Rh leach. |
|---|---|---|---|---|---|---|---|
| support type | Rhodium catalyst complex | no. | time (h) | (%) | (h⁻¹) | (%) | (ppm) |
| NK-1 | [((−)-BINAP)Rh(NBD)]PF₆ | 1 | 2 | 22.33 | 18.3 | 15.0 | 0.324 |
| | | 2 | 2 | 19.85 | 16.2 | 12.8 | 0.285 |
| | | 3 | 2 | 23.60 | 19.3 | 13.7 | 0.256 |
| | | 4 | 17 | 77.93 | 7.5 | 10.6 | 0.360 |
| | | 5 | 2 | 8.08 | 6.6 | 8.1 | 0.277 |
| NK-1 | [((−)-DIOP)Rh(NBD)]PF₆ | 1 | 2 | 34.80 | 28.6 | 17.3 | 0.238 |
| | | 2 | 2 | 20.12 | 16.5 | 17.3 | 0.319 |
| | | 3 | 2 | 19.28 | 15.8 | 18.1 | 0.271 |
| | | 4 | 17 | 53.90 | 5.2 | 14.7 | 0.773 |
| | | 5 | 2 | 3.92 | 3.0 | 19.9 | 0.306 |
| NK-1 | [((−)-TMBTP)Rh(NBD)]PF₆ | 1 | 2 | 26.39 | 21.6 | 98.5 | 0.732 |
| | | 2 | 2 | 27.10 | 22.2 | 97.0 | 0.792 |
| | | 3 | 2 | 23.72 | 19.4 | 97.0 | 0.000 |
| | | 4 | 17 | 72.99 | 7.0 | 94.0 | 0.719 |
| | | 5 | 2 | 7.70 | 6.3 | 96.0 | 0.664 |
| NK-1 | [((−)-Monophos)₂Rh(NBD)]PF₆ | 1 | 2 | 20.51 | 16.8 | 90.5 | 0.570 |
| | | 2 | 2 | 14.98 | 12.3 | 88.0 | 0.346 |
| | | 3 | 2 | 15.21 | 12.5 | 89.3 | 0.620 |
| | | 4 | 17 | 93.87 | 9.0 | 94.0 | 1.050 |
| | | 5 | 2 | 14.39 | 11.8 | 89.0 | 0.375 |
| CSNKW-1 | [((−)-BINAP)Rh(NBD)]PF₆ | 1 | 2 | 93.01 | 76.3 | 11.0 | 0.452 |
| | | 2 | 2 | 74.15 | 60.8 | 3.2 | 1.917 |
| | | 3 | 2 | 57.53 | 47.2 | 2.2 | 0.153 |
| | | 4 | 17 | 95.57 | 9.2 | 1.4 | 1.874 |
| | | 5 | 2 | 18.64 | 15.3 | 5.9 | 0.026 |
| CSNKW-1 | [((−)-DIOP)Rh(NBD)]PF₆ | 1 | 2 | 51.25 | 41.8 | 17.6 | 1.418 |
| | | 2 | 2 | 36.29 | 29.6 | 16.4 | 1.329 |
| | | 3 | 2 | 21.21 | 17.3 | 14.8 | 1.040 |
| | | 4 | 17 | 52.76 | 5.1 | 11.0 | 1.290 |
| | | 5 | 2 | 5.00 | 4.1 | 17.0 | 0.807 |
| CSNKW-1 | [((−)-TMBTP)Rh(NBD)]PF₆ | 1 | 2 | 91.81 | 75.3 | 98.3 | 1.739 |
| | | 2 | 2 | 50.44 | 41.3 | 97.6 | 1.165 |
| | | 3 | 2 | 32.48 | 26.6 | 98.8 | 1.292 |
| | | 4 | 17 | 67.85 | 6.5 | 93.0 | 2.166 |
| | | 5 | 2 | 5.08 | 4.2 | 93.0 | 0.527 |
| CSNKW-1 | [((−)-Monophos)₂Rh(NBD)]PF₆ | 1 | 2 | 24.40 | 20.0 | 90.5 | 1.084 |
| | | 2 | 2 | 17.66 | 14.5 | 90.2 | 1.014 |
| | | 3 | 2 | 15.45 | 12.7 | 89.5 | 0.347 |
| | | 4 | 17 | 80.79 | 7.8 | 90.8 | 1.680 |
| | | 5 | 2 | 9.38 | 7.7 | 83.5 | 0.413 |
| CSNKW-3 | [((−)-Monophos)₂Rh(NBD)]PF₆ | 1 | 2 | 30.78 | 25.2 | 79.5 | |
| | | 2 | 2 | 12.64 | 10.4 | 62.6 | |
| | | 3 | 2 | 7.34 | 6.0 | 45.0 | |
| | | 4 | 17 | 13.77 | 1.3 | 45.5 | |
| | | 5 | 2 | 4.37 | 3.6 | 0.0 | |
| NKS-1 | [((−)-Monophos)₂Rh(NBD)]PF₆ | 1 | 2 | 15.64 | 12.8 | 61.0 | |
| | | 2 | 2 | 15.56 | 12.7 | 60.3 | |
| | | 3 | 2 | 14.31 | 11.7 | 62.5 | |
| | | 4 | 17 | 45.85 | 4.4 | 67.1 | |
| | | 5 | 2 | 5.89 | 4.8 | 27.0 | |
| NKW-6 | [((−)-Monophos)₂Rh(NBD)]PF₆ | 1 | 2 | 22.43 | 18.4 | 74.3 | |
| | | 2 | 2 | 19.17 | 15.7 | 77.7 | |
| | | 3 | 2 | 15.77 | 12.9 | 59.0 | |
| | | 4 | 17 | 71.99 | 6.9 | 71.8 | |
| | | 5 | 2 | 12.66 | 10.4 | 73.5 | |

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. Catalytic materials composed of hybrid inorganic/polymeric support materials and molecular catalysts immobilized onto them, wherein the hybrid inorganic/polymeric support material consists of a hybrid inorganic/polymeric compound in which inorganic compounds and organic polymers are chemically combined, and the immobilized molecular catalyst is a preformed metal catalyst which provides specific product selectively for specific chemical reaction.

2. Catalytic material according to claim 1, wherein the hybrid inorganic/polymeric support material is hybrid inorganic/polymeric membrane and the catalytic material is a catalytic membrane.

3. Catalytic material according to claim 1, wherein the immobilized molecular catalyst is a molecular enantioselective catalyst.

4. Catalytic material according to claim 1, wherein the hybrid inorganic/polymeric compound consists of organic polymer and at least one inorganic compound selected from silicic acid compound, tungstic acid compound, molybdic acid compound and stannic acid compound.

5. Catalytic material according to claim 1, wherein the hybrid inorganic/polymeric compound consists of organic polymer and at least one inorganic compound selected from silicic acid compound and tungstic acid compound.

6. Catalytic material according to claim 1, wherein the hybrid compound consists of inorganic compounds and a water-soluble organic polymer.

7. Catalytic material according to claim 1, wherein the hybrid compound consists of inorganic compounds and organic polymers having hydroxyl groups.

8. Catalytic material according to claim 7, wherein the organic polymer having hydroxyl group is polyvinylalcohol.

9. Catalytic material according to claim 1, wherein the hybrid inorganic/polymeric compound contains polymer having sulfonic acid groups.

10. Catalytic material according to claims 9, wherein the polymer having sulfonic acid groups is polystyrenesulfonic acid.

11 Catalytic material according to claim 1, wherein the hybrid inorganic/polymeric compound contains polyethylene gycol.

12. Catalytic material according to claim 2, wherein the hybrid inorganic/polymeric membrane has porous matrix sheet for reinforcement.

13. Catalytic material according to claim 1, wherein the preformed metal catalyst is any catalytically active material which contains at least one transition metal atom or ion selected from groups IB, IIB, IVB, VB, VIB, VIIB, VIII of the Periodic Table of Elements to which one or more ligands are attached.

14 Catalytic material according to claim 13, wherein the transition metal atoms or ions include at least one selected from Sc, Ti, V, Cr, Mn, Co, Ni, Cu, Zn, Zr, Mo, Ru, Rh, Pd, Ag, W, Re, Os, Ir, Pt, Au.

15. Catalytic material according to claim 13, wherein the ligand is selected from organic or metal-organic species containing one or more donor atoms having at least a free electronic pair or any other donor moieties which are able to coordinate the metal atoms or ions.

16. Catalytic material according to claim 15, wherein the donor atoms include phosphorus, nitrogen, oxygen, sulphur, carbon, halogen atoms and/or mixed-donor atom sets.

17. Catalytic material according to claim 15, wherein the ligand includes phosphines, amines, imines, ethers, carbonyls, alkenes, alkadienes, methanol, nitriles, dimethylsulfoxide, halides and their mixture thereof.

18. Catalytic material according to claim 3, wherein the immobilized catalyst is a preformed metal catalyst which contains at least one chiral ligand.

19. Catalytic material according to claims 18 wherein the preformed metal catalyst contains at least one transition metal atom or ion selected from Ru, Rh, Pd, Ir, Ni, Pt, Au and at least one chiral ligand selected from organic or metal-organic species including phosphino, amino or amino-phosphino species or there mixture thereof.

20. Catalytic material according to claim 3, wherein the immobilized catalyst is a preformed metal complex which contains at least one ligand selected from (R,R) or (S,S)-BINAP [2,2′-bis(diphenylphosphino)-1,1′.binaphtalene], (R,R) or (S, S)-DIOP [2,3 -O-isopropylidene-2,3-dihydroxy-1,4-bis(diphenylphosphino)butane], (R) or (S)-Monophos [(3,5-dioxa-4-phosphacyclohepta[2,1-a;3,4-a]dinaphtalen-4-yl)dimethylamine], (R,R) or (S, S)-TMBTP [4,4′-bis(diphenylphosphino)-2,2′,5,5′-tetramethyl-3,3′-bithiophene].

21. Catalytic material according to claim 3, wherein the immobilized catalyst is a preformed metal complex selected from [(-)-(TMBTP)Rh(NBD)]PF₆, [(-)-(BINAP)Rh(NBD)]PF₆, [(-)-(DIOP)Rh(NBD)]PF₆ and [(-)-(Monophos)₂Rh(NBD)]PF₆.

22. Catalytic material according to claim 1, wherein the specific chemical reaction is hydrogenation, dehydrogenation, hydroformylation, carbonylation, oxidation, dihydroxylation, epoxidation, amination, phosphination, carboxylation, silylation, isomerization, allylic alkylation, cyclopropanation, alkylation, arylation, methatesis and other C-C bond forming reaction.

23. Catalytic material according to claim 1, wherein the specific chemical reaction is enantioselective hydrogenation of a prochiral substrate including olefins, imines, enamines, ketones, α,β-unsaturated alcohols, ketons, esters or acids.

24. Catalytic material according to claim 1, wherein the specific chemical reaction is the enantioselective hydrogenation of the prochiral olefin of the formula: 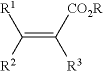
where R is hydrogen, alkyl containing from 1 to about 30 carbon atoms, aryl containing about from 6 to 18 carbon atoms, R₁, R₂ and R₃ contain hydrogen, alkyl containing from 1 to about 30 carbon atoms, alkenyl containing from 1 to about 30 carbon atoms, alkynyl containing from 1 to about 30 carbon atoms, aryl containing about from 6 to 18 carbon atoms, amide, amine, alkoxide containing from 1 to about 30 carbon atoms, ester containing from 1 to 30 carbon atoms, ketone containing from 1 to about 30 carbon atoms, the aryl substituents may be biciclyc, fused species or containing heteroatoms such as sulfur, oxygen, nitrogen or phosphorus.

25. A method for manufacturing catalytic material according to claim 4, wherein the hybrid inorganic/polymeric compound is formed by casting and drying a precursor solution, which is prepared by neutralizing at least one species of inorganic oxide salt selected from silicate, tungstate, molybdate and stannate by acid in the solution containing an organic polymer.

26. A method for manufacturing catalytic material according to claim 25, wherein the precursor solution is prepared by neutralizing at least one species of inorganic oxide salt selected from silicate, tungstate, molybdate and stannate by acid in the solution containing an organic polymer having hydroxyl group.

27. A method for manufacturing catalytic material according to claim 25, wherein the organic polymer having hydroxyl groups is polyvinylalcohol.

28. A method for manufacturing catalytic material according to claim 1, by contacting a hybrid inorganic/polymeric support material with an appropriate solution of a preformed metal catalyst.

29. A catalytic material according to claim 2, wherein the specific chemical reaction is performed with a fixed-bed catalytic membrane or a rotating catalytic membrane.

30. A catalytic material according to claim 22, wherein the catalyst manufacture and the specific chemical reaction are performed in a two separated step procedure or in a single-pot sequence by contacting a hybrid inorganic/polymeric support material with an appropriate solution of a performed metal catalyst.
